(19) United States
(12) Patent Application Publication
(10) Pub. No.: US 2006/0236028 A1
(43) Pub. Date: Oct. 19, 2006

(54) Storage device and controlling method thereof

(75) Inventors: Katsuya Tanaka, Kokubunji (JP); Tetsuya Shirogane, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/471,911

(22) Filed: Jun. 20, 2006

Related U.S. Application Data
(63) Continuation of application No. 10/770,723, filed on Feb. 2, 2004.

(30) Foreign Application Priority Data
Nov. 17, 2003 (JP) 2003-386287

(51) Int. Cl. G06F 12/00

(52) U.S. Cl. 711/112

(57) ABSTRACT

A disk adapter and disk drives, each having dual ports, are connected in dual loops via a switch. A destination loop to which a command is to be transferred is determined, according to the type (Read/Write) of the command that the disk adapter issues to one of the disk drives. The disk adapter issues Read and Write commands so that the Read exchange and the Write exchange are executed in parallel.

### BACKGROUND OF THE INVENTION

In current computer systems, data required by a CPU (Central Processing Unit) is stored in secondary storage devices and writing data to and reading data from the secondary storage devices are performed when necessary for the CPU and related operation. As these secondary storage devices, nonvolatile storage media are generally used, typified by disk devices comprising magnetic disk drives, optical disk drives, and the like. With advancement of information technology in recent years, there is a demand for higher performance of these secondary storage devices in the computer systems.

As I/O interfaces of high performance disk devices, Fibre Channel is often used. Connection topologies of the Fiber Channel are shown in FIGS. 20, 21, and 22. FIG. 20 shows a “point to point” topology. In this topology, Fibre Channel ports are called N_Ports and interconnection between a pair of N_Ports is made by two physical channels through which data is transmitted and received between the ports. FIG. 21 shows an “Arbitrated Loop” topology (hereinafter referred to as FC-AL). Fibre-Channel ports in the FC-AL topology are called NL_Ports (Node Loop Ports) and the NL_Ports are connected in a loop in this topology. The FC_AL is mostly applied to cases where a number of disk drives are connected. FIG. 22 shows a “Fabric” topology. In this topology, the ports (N_Ports) of servers and storage devices are connected to the ports (F_Ports) of a Fibre Channel switch. In the point to point topology and the Fabric topology, a full duplex data transfer between a pair of ports connected is enabled.

FIGS. 23 and 24 show examples of exchange according to Fibre Channel Protocol for SCSI (hereinafter referred to as FCP). In general, an exchange operation consists of sequences and a sequence consists of (one or a plurality of) frames in which a series of actions are performed. FIG. 23 shows an exchange example for Read. A Read command is sent from an initiator to a target (FCP_CMND). In response to this command, data is read and sent from the target to the initiator (FCP_DATA). Finally, status information is sent from the target to the initiator (FCP_RSP), then, the exchange ends. FIG. 24 shows an exchange example for Write. A Write command is sent from the initiator to the target (FCP_CMND). At appropriate timing, buffer control information is sent from the target to the initiator (FCP_XFER_RDY). In response to this, data to write is sent from the initiator to the target (FCP_DATA). Finally, status information is sent from the target to the initiator (FCP_RSP), then, the exchange ends. In this way, under the FCP, data is transferred in one direction at a time and half duplex operation is performed in most cases. A mode in which, while a port transmits data, the port receives another data in parallel with the transmission, is referred to as full duplex operation.

Because Fiber Channel enables the full duplex data transfer, application of the full duplex operation under the FCP improves data transfer capability. As Prior Art 1 to realize the full duplex data transfer under the FCP, for example, there is a method described in a white paper “Full-Duplex and Fibre Channel” issued by Qlogic Corporation (http://www.qlogic.com/documents/datasheets/knowledge_data/whitepapers/tb_duplex.pdf). In the Prior Art 1, a plurality of FC-ALs in which disk drives are connected and a server are connected via a switch and parallel data transfers are carried out between the server and the plurality of FC-ALs.

A method for realizing the full duplex data transfer between a host processing device and a storage controlling device of a disk device is disclosed in Japanese Published Unexamined Patent Application No. 2003-85117 “Storage Control Device and Its Operating Method.” The prior-art described in this bulletin will be referred to as Prior Art 2 hereinafter. In the Prior Art 2, channel processors for inputting data to and outputting data from the disk device are controlled in accordance with a command from the host device and the quantity of data to be transferred so that full duplex operation is performed between the host device and the storage controlling device.

A disk array system where a disk array controller and disk drives are connected via a switch is disclosed in Japanese Published Unexamined Patent Application No. 2000-222339-“Disk Sub-system.” The prior art described in this bulletin will be referred to as Prior Art 3 hereinafter.

### SUMMARY OF THE INVENTION

With advance in network technology, the data transfer rate per channel is increasing year by year. For example, in the case of the Fiber Channel used for disk devices, at the present, the data transfer rate per channel ranges from 1 to 2 Gbps and a plan is made to boost this rate up to 4 to 10 Gbps in the near future. Throughput between a server and a disk device (hereinafter referred to a front-end) is expected to become higher with the increasing transfer rate per channel. However, it is anticipated that throughput between a disk adapter and a disk array within a disk device (hereinafter referred to as a back-end) is not becoming so high as the throughput of the front-end for the following reasons.

First, because a disk drive contains mechanical parts, the throughput in the back-end is harder to raise than in the front-end where only electronic and optical elements are to be improved to raise the throughput. Second, even if a disk drive is enhanced to operate at a sufficiently highs rate, a disk device having a considerable number of disk drives which are all equipped with high-speed interfaces will be high cost. As a solution, it is conceivable to take advantage of the full duplex data transfer capability of the Fiber Channel without boosting the transfer rate per channel, thereby raising the throughput in the back-end of the disk device.

A disk drive having a Fibre Channel interface is generally equipped with a plurality of I/O ports in order to enhance reliability. The Prior Art 1 does not take a disk drive having a plurality of I/O ports into consideration and it is difficult to apply the Prior Art 1 to a disk device comprising disk drives each having a plurality of I/O ports in the back-end.

In the Prior Art 2, dynamic control is required when data is transferred and its problem is complexity of the control method. Also, the document describing the Prior Art 2 does not deal with the full duplex data transfer in the back-end of a disk device.

The document describing the Prior Art 3 does not deal with application of the Prior Art 3 to the back-end of a disk drive equipped with a plurality of I/O ports and the full duplex data transfer in the back-end.

It is an object of the present invention to provide a disk device having a full duplex data transfer network suitable for the back-end of the disk device.

It is another object of the present invention to provide a disk device having a high-reliability back-end network.

In order to achieve the foregoing objects, the Applicant offers a disk device comprising a disk controller, which comprises a channel adapter, a cache memory, and a disk adapter, and a disk array, which comprises disk drives, each being equipped with a plurality of I/O ports, wherein the disk adapter and the disk array are connected via a switch and wherein a destination drive I/O port to which a frame is to be forwarded is determined, according to the type of a command included in an exchange that is transferred between the disk adapter and one of the disk drives.

In this disk device, yet, the destination drive port to which the frame is to be forwarded is determined, depending on whether the type of the command is a data read command or a data write command.

In this disk device, moreover, an exchange for reading data and an exchange for writing data are executed in parallel.

In this disk device, furthermore, a path which a frame passes to be transferred between the switch and one of the disk drives is determined, according to the type of a command included in an exchange between the disk adapter and the one of the disk drives.

In this disk device, yet, the path which the frame passes between the switch and the one of the disk drives is determined, depending on whether the type of the command is a data read command or a data write command.

In this disk device, furthermore, the disk adapter determines destination information within a frame to be transferred from the disk adapter to one of the disk drives, according the type of a command included in an exchange between the disk adapter and the one of the disk drives, and the switch selects one of port to port connection paths between a port to which the disk adapter is connected and ports to which the disk drives constituting the disk array are connected to switch each frame inputted to the switch, according to destination information within the frame.

In this disk device, yet, the switch selects one of the port to port connection paths between the port to which the disk adapter is connected and the ports to which the disk drives constituting the disk array are connected to switch each frame inputted to the switch, according to the type of a command included in an exchange between the disk adapter and one of the disk drives and the destination information within a frame.

In this disk device, moreover, the switch modifies a frame to be transferred from the disk adapter to one of the disk drives, wherein the switch changes the destination information and error control code within the frame, and modifies a frame to be transferred from one of the disk drives to the disk adapter, wherein the switch changes source information and the error control code within the frame.

In this disk device, furthermore, the disk adapter and a first group of ports of the disk drives are connected via a first switch and the disk adapter and a second group of ports of the disk drives are connected via a second switch, and the first switch and the second switch are connected, and a destination drive I/O port to which a frame is to be forwarded is determined, according to the type of a command included in an exchange between the disk adapter and one of the disk drives.

In this disk device, yet, a first disk adapter and the first group of ports of the disk drives are connected via the first switch, the first disk adapter and the second group of ports of the disk drives are connected via the second switch, a second disk adapter and the second group of ports of the disk drives are connected via the second switch, the second disk adapter and the first group of ports of the disk drives are connected via the first switch, and the first switch and the second switch are connected, and a destination drive I/O port to which a frame is to be forwarded is determined, according to the type of a command included in an exchange between the first disk adapter or the second disk adapter and one of the disk drives.

### BRIEF DESCRIPTION OF THE DRAWINGS

FIG. 1 is a diagram showing a disk device according to Embodiment 1 of the invention;

FIG. 2 is a diagram showing a configuration example of a channel adapter;

FIG. 3 is a diagram showing a configuration example of a disk adapter;

FIG. 4 is a diagram showing a back-end arrangement example;

FIG. 5 is a diagram showing a switch configuration example;

FIG. 6 shows an example of a management table that is referenced by the disk adapter;

FIG. 7 shows another example of the management table that is referenced by the disk adapter;

FIG. 8 is diagram showing a switch configuration used in Embodiment 2;

FIG. 9 shows an example of FCP_CMND frame structure;

FIG. 10 is a flowchart illustrating an example of processing that the switch performs;

FIGS. 11A and 11B show examples of management tables that are referenced by the switch;

FIG. 12 is a diagram showing a disk device according to Embodiment 3 of the invention;

FIG. 13 shows a management table that is referenced in Embodiment 3;

FIGS. 14A, 14B, and 14C are topology diagrams which are compared to explain the effect of Embodiment,

FIG. 15 is a graph for explaining the effect of Embodiment 3;

FIG. 16 shows another example of the management table that is referenced in Embodiment 3;

FIG. 17 is a diagram showing a disk device according to Embodiment 4 of the invention;

FIG. 18 shows, a management table that is referenced in Embodiment 4;

FIG. 19 is a diagram showing a disk device according to Embodiment 5 of the invention;

FIG. 20 is a diagram explaining a point to point topology;

FIG. 21 is a diagram explaining an Arbitrated Loop topology;

FIG. 22 is a diagram explaining a Fabric topology;

FIG. 23 is a diagram explaining an exchange for Read operation;

FIG. 24 is a diagram explaining an exchange for Write operation;

FIG. 25 is a diagram explaining an example of concurrent execution of Read and Write exchanges; and

FIG. 26 shows another example of the back-end management table.

### DESCRIPTION OF THE PREFERRED EMBODIMENTS

Preferred embodiments of the present invention will be described hereinafter with reference to the accompanying drawings. It will be appreciated that the present invention is not limited to those embodiments that will be described hereinafter.

### Embodiment 1

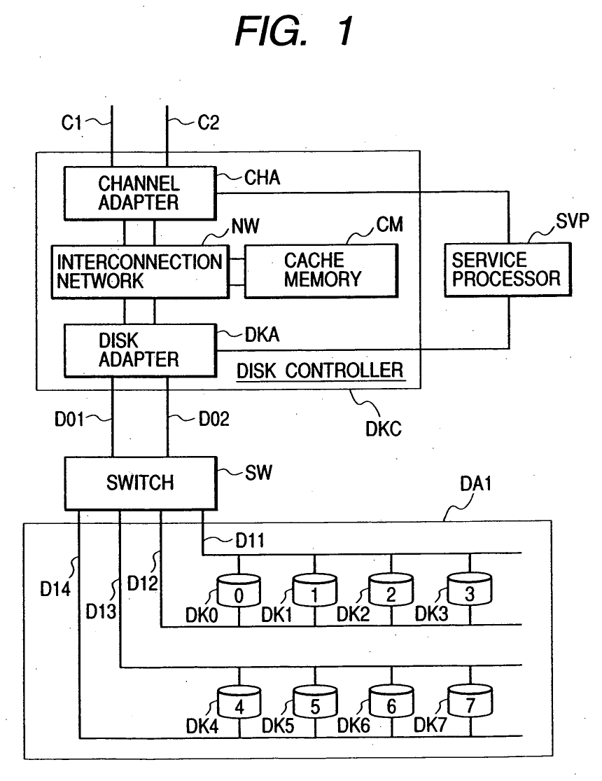

FIG. 1 shows a disk-device configuration according to a preferred Embodiment 1 of the invention. The disk device is comprised of a disk controller (DKC), a disk array (DA1), and a switch (SW). The disk controller (DKC) is comprised of a channel adapter (CHA), a cache memory (CM), and a disk adapter (DKA). The channel adapter (CHA), the cache memory (CM), and the disk adapter (DKA) are connected by an interconnection network (NW). The channel adapter (CHA) connects to a host system (not shown) through channels (C1) and (C2). The disk adapter (DKA) is connected to the disk array (DA1) through channels (D01) and (D02) and via the switch (SW).

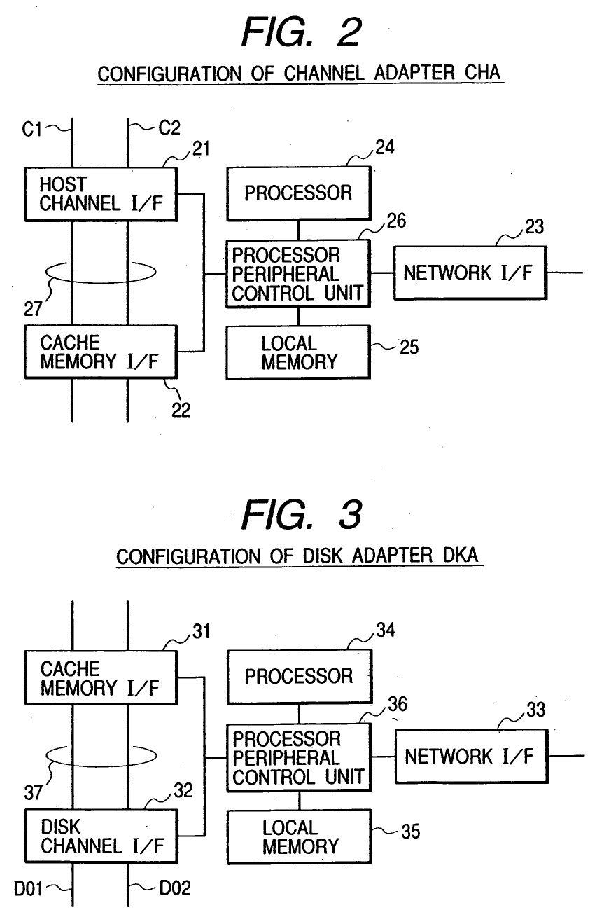

FIG. 2 shows a configuration of the channel adapter.

The channel adapter is comprised of a host channel interface 21 on which the channels C1 and C2 terminated, a cache memory interface 22 connected to the interconnection network, a network interface 23 for making connection to a service processor, a processor 24 for controlling data transfer between the host system and the channel_adapter, a local memory 25 on which tables to be referenced by the processor and software to be executed have been stored, and a processor peripheral control unit 26 interconnecting these constituent elements.

The service processor (SVP) is used to set or change entries in the tables that are referenced by the processor 24 and a processor 34 (which will be mentioned later) or to monitor the disk device operating status.

The host channel interface 21 has a function to make conversion between a data transfer protocol on the channel paths C1 and C2 and a data transfer protocol within the disk controller. The host channel interface 21 and the cache memory interface 22 are connected by signal lines 27.

FIG. 3 shows a configuration of the disk adapter.

The disk adapter is comprised of a cache memory interface 31 connected to the interconnection network, a disk channel interface 32 on which the disk channels D01 and D02 terminated, a network interface 33 for making connection to the service processor, a processor 34, a local memory 35 on which tables to be referenced by the processor and software to be executed have been stored, and a processor peripheral control unit 36 interconnecting these constituent elements.

The cache memory interface 31 and the disk channel interface 32 are connected by signal lines 37. The disk channel interface 32 is provided with a function to make conversion between the data transfer protocol within the disk controller and a data transfer protocol, for example, FCP, on the disk channels D01 and D02.

The structure of the disk array (DA1) in the disk device of Embodiment 1 is described. The disk array (DA1) shown in FIG. 1 consists of a disk array made up of four disk drives connected on channels D11 and D12 and a disk array made up of four disk drives connected on channels D13 and D14. By way of example, on the channel D11, disk drives DK0, DK1, DK2, and DK3 are connected. As a method in which to connect a number of drives on one channel in this way and allow access to the disk drives, Fibre Channel Arbitrated Loop (hereinafter referred to as FC-AL) is used.

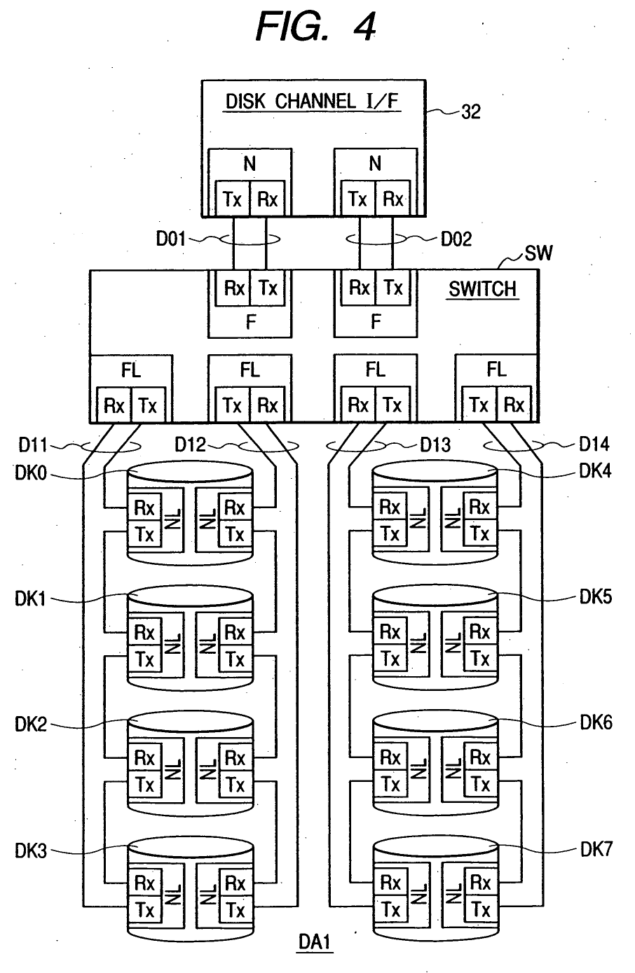

FIG. 4 shows detail of the FC-AL topology used in Embodiment 1. The disk drives each have two NL ports. Each I/O port of each disk drive and each I/O port of the switch has a transmitter Tx and a receiver Rx. The switch I/O ports for connections to the disk array DA1 are FL (Fabric Loop) ports. The switch and the disk drives DK0, DK1, DK2, and DK3 are connected in a loop through the channel D11. Likewise, the switch and the disk drives DK0, DK1, DK2, and DK3 are connected in a loop through the channel D12. These two loops are public loops as Fibre Channel loops and the disk drives DK0, DK1, DK2, and DK3 are able to communicate with the disk channel interface 32 of the disk adapter via the switch. While one side of the FC-AL topology example through the channels D11 and D12 has been described above, the same description applies to the other side of the FC-AL topology through the channels D13 and D14 as well.

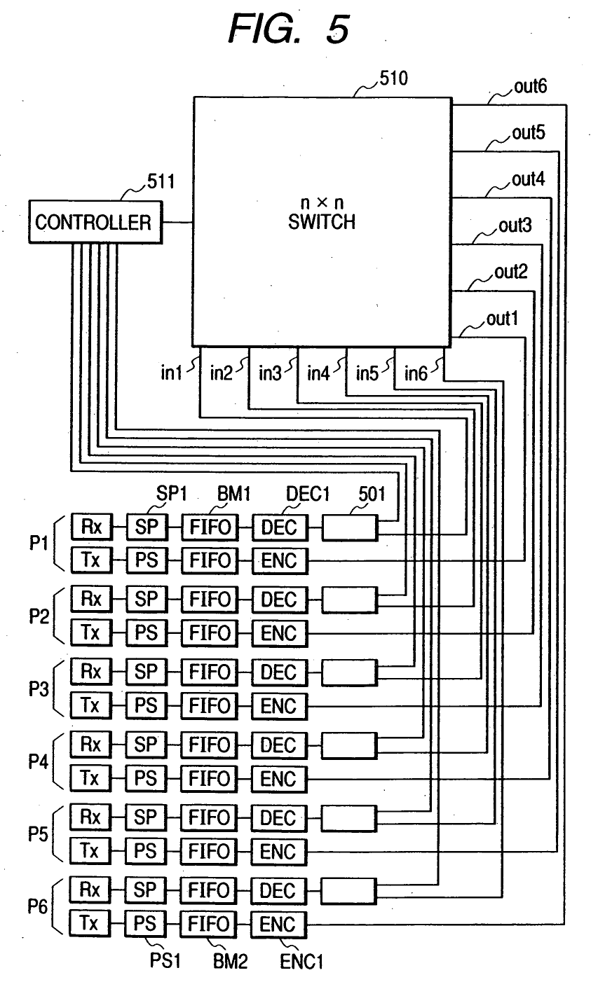

Next, switch operation of Embodiment 1 is discussed. As is shown in FIG. 5, the switch has I/O ports P1, P2, P3, P4, P5, and P6. The ports P1, P2, P3, P4, P5, and P6 are I/O ports that enable full duplex data transfer. As an example of operation, an instance where a frame is inputted through the port P1 and outputted through one of the ports P2, P3, P4, P5, and P6 is described. As is shown in FIG. 5, the switch consists of a crossbar switch 510 and a switch controller 511. The crossbar switch 510 is a 6×6 crossbar switch in this example and has input ports in1, in2, in3, in4, in5, and in6 and output ports out1, out2, out3, out4, out5, and out6.

The frame inputted from the port P1 passes through a serial-to-parallel converter SP1, a buffer memory BM1, an 8B/10B decoder DC1, and a frame header analyzer 501, and inputted to the switch controller 511 and the input port in1. The switch controller 511 makes a forwarding decision and causes the crossbar switch 510 to switch the frame to the appropriate port, according to the destination port ID specified in the header of the inputted frame. By way of example, if the port of a device connected to the port P6 is selected as the destination, the inputted frame is routed through the output port out6, an 8B/10B encoder ENC1, a buffer memory BM2, and a parallel-to-serial converter PS1, and outputted from the port 6. Here, the buffer memories BM1 and BM2 are FIFO (First-In First-Out) memories.

In this manner of the connection of the disk adapter and the disk array DA1 via the switch, the disk adapter can send a frame to an arbitrary I/O port of one of the disk drives DK0 to DK7.

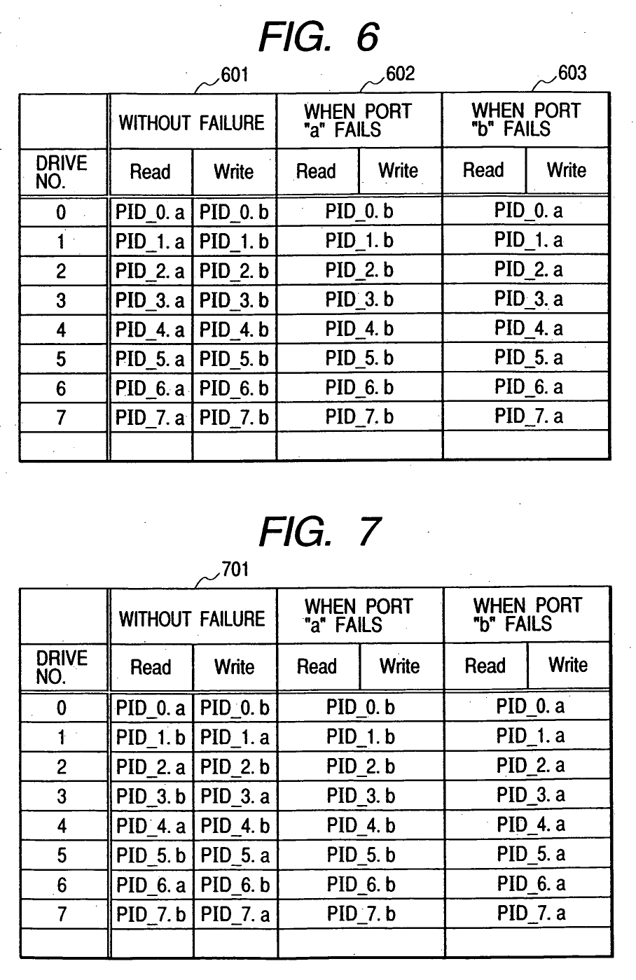

Although the disk adapter and the switch are connected by the two channels D01 and D02 in FIG. 1, now, suppose that only the channel D01 be used to simplify explanation. FIG. 6 shows an example of a back-end management table that is referenced by the processor 34 within the disk adapter. For a drive number, a destination drive port ID to which a Read command is addressed and a destination drive port ID to which a Write command is addressed are set in a column 601 in the table of FIG. 6. In the column 601, PID_0.a to PID_7.a correspond to the port IDs of the disk drives in the FC-AL connected with the channel D11 or the channel D13. PID_0.b to PID_7.b correspond to the port IDs of the disk drives in the FC-AL connected with the channel D12 or the channel D14. During normal operation (the ports of each drive operate normally), a Read command sent from the disk adapter is carried through the channel D01 and forwarded through the switch to any one of the destination ports PID_0.a to PID 7.a. Data that has been read is transferred in a reverse direction through the same path that the Read command was transferred. Meanwhile, a Write command and data to write are carried through the channel D01 and forwarded through the switch to any one of the destination ports PID_0.b to PID_7.b.

By way of example, operations of Read from a disk drive with drive number 0 and Write to a disk drive with drive number 1 are described. The processor 34 shown in FIG. 3 references the column 601 in the table of FIG. 6 and sends a Read command to the PID_0.a port and a Write Command to the PID_1.b port. The Read command is transferred through a path going from the disk adapter, through the channel D01, the switch, the channel D11, and to the PID_0.a port. The Write command is transferred through a path going from the disk adapter, through the channel D01, the switch, the channel D12, and to the PID_1.b port. Because two different paths through which data can be transferred between the switch and the disk array are provided in this way and one of these paths is selected, according to the command type (Read/Write), a Read exchange and a Write exchange can be executed in parallel.

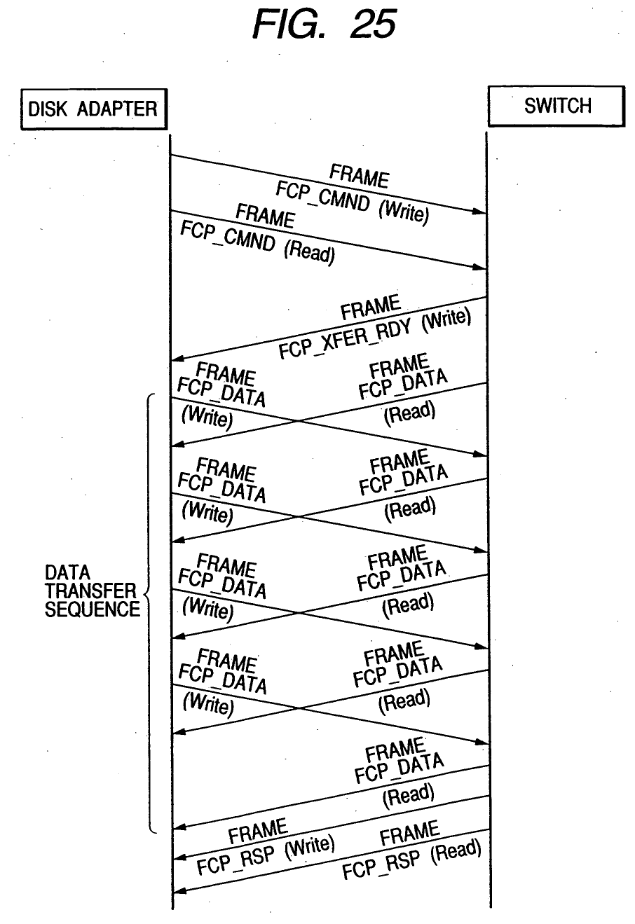

FIG. 25 is a diagram showing an example of exchanging frames between the disk adapter and the switch (on the channel D01) for the case of parallel execution of Read and Write exchanges. The disk adapter issues the Read command and the Write command so that data transfer sequence of the Read exchange coincides with that of the Write exchange. The disk adapter need not always issue, the Read command and the Write command simultaneously. The Read exchange and the Write exchange need not always be equal in data transfer size. Moreover, parallel execution of a plurality of Read exchanges and a plurality of Write exchanges is possible.

During the above exchanges, on the channel D01, bidirectional data transfers are performed in parallel. In other words, the channel between the disk adapter and the switch is placed in a full duplex operation state. When the processor 34 issues the Read and Write commands so that the data transfer sequence of the Read exchange coincides with that of the Write exchange, these exchanges are processed by the full duplex operation between the disk adapter and the switch. To determine the destination port IDs to which the Read and Write commands are addressed, the disk adapter just has to reference the management table only once at the start of the exchanges. In this way, by very simple means, full duplex operation can be realized.

If one of the two ports of a disk drive has failed, the settings in column 602 or 603 in the table of FIG. 6 are applied, and the disk adapter can get access to the disk array DA1. For example, suppose that Read access to the disk drive with drive number 2 is attempted, but the PID_2.a port has failed. In that event, the processor 34 references the corresponding setting in the column 602 and determines to send the Read command to the PID_2.b port of the disk drive with drive number 2. Likewise, suppose that Write access to the disk drive with drive number 3 is attempted, but the PID_3.b port has failed. In that event, the processor 34 references the corresponding setting in the column 603 and determines to send the Write command to the PID_3.a port of the disk drive with drive number 3.

FIG. 7 shows another example of the back-end management table. Difference from the management table of FIG. 6 is that destination ports to which a Read command is addressed and destination ports to which a Write command is addressed are set up in the same FC-AL, for example, as assigned in column 701. In this case, Read and Write exchanges share the bandwidth of the same FC-AL. However, for example, when Read access to the disk drive with drive number 0 and Write access to the disk drive with drive number 2, these exchanges belonging to different FC-ALs, are executed in parallel, bidirectional data transfers are performed in parallel on the channel D01. Even if the ports of the disk drives are set to receive access requests for Read and Write exchanges in the same FC-AL, full duplex operation can be performed without a problem and a higher throughput than when half duplex operation is performed is achieved.

In Embodiment 1 described hereinbefore, the disk adapter determines the destination port of a disk drive, according to the type (Read/Write) of a command it issues. Processing that produces the same result can be performed in the switch as well.

### Embodiment 2

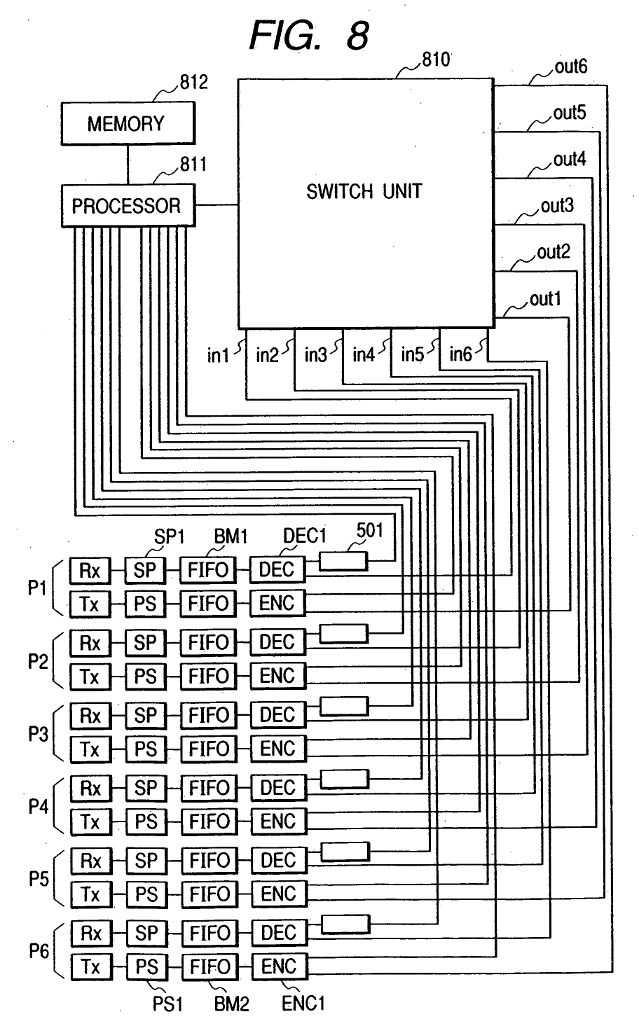

FIG. 8 through FIGS. 11A and 11B are provided to explain a preferred Embodiment 2. In Embodiment 2, the switch modifies information within a frame so that full duplex operation is implemented, irrespective of the destination drive port set by the disk adapter.

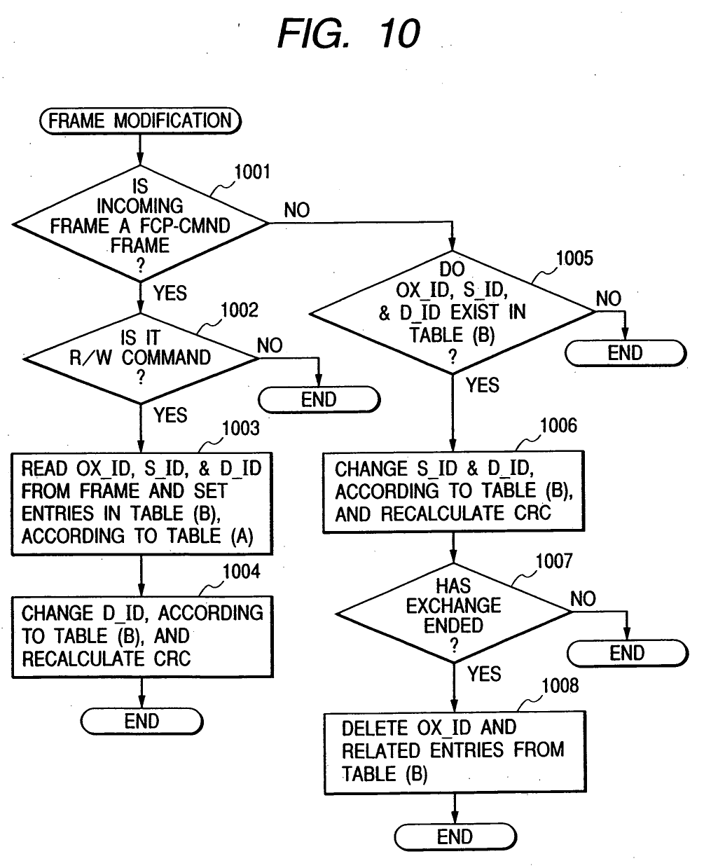

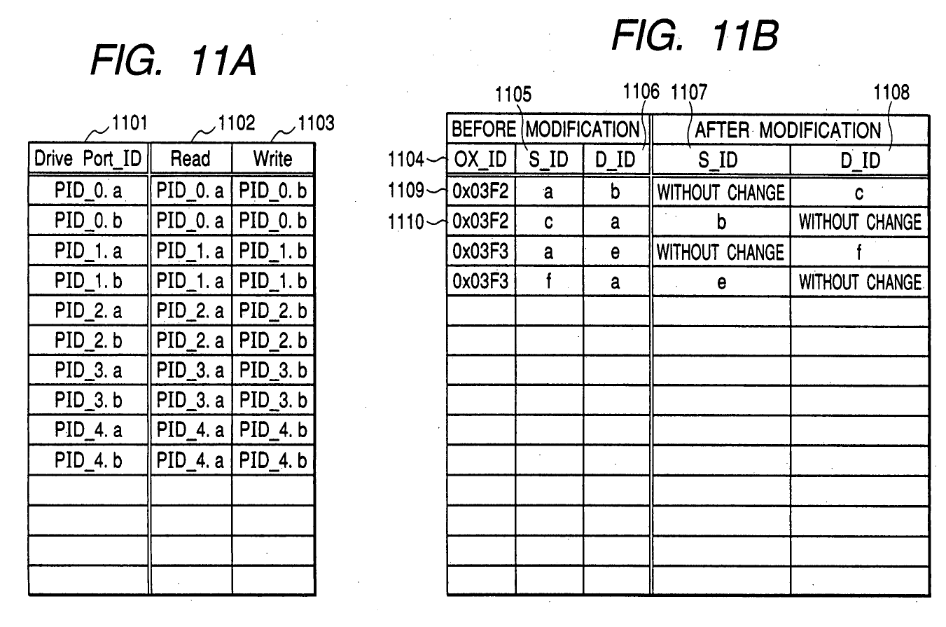

FIG. 8 shows a switch configuration used in Embodiment 2. To the switch configuration of FIG. 5, a memory 812 is added, and a switch unit 810 is a shared memory type. A processor 811 is able to read data from and write data to frames stored on the shared memory switch 810. On the memory 812, management tables which are shown in FIGS. 11A and 11B are stored. The processor 811 executes frame modification processing, according to a flowchart of FIG. 10. In the management table of FIG. 11A, a destination port ID 1101 within a frame sent from the disk adapter to the switch is mapped to alternate port IDs 1102 and 1103. A column 1102 contains alternate port IDs for Read exchanges and a column 1103 contains alternate port IDs for Write exchanges. The management table of FIG. 11B contains entries and associated modification to be set per exchange, which are set, according to the flowchart of FIG. 10, and referenced.

The processing according to the flowchart of FIG. 10 is executed each time a frame passes through the switch. Specifically, this frame modification processing is executed when I/O operation is performed between the disk adapter and the switch. To prevent duplicated execution, this processing is not executed when I/O operation is performed between the switch and the disk array.

In step 1001, the processor 811 checks if an incoming frame is FCP_CMND and determines whether a command initiates a new exchange. If the frame is FCP_CMND, then the processor 811 detects the type of the command in step 1002. If the command is Read or Write, the procedure proceeds to step 1003.

In step 1003, the processor 811 reads OX_ID as exchange ID, D_ID as destination ID, and S_ID as source ID from the FCP_CMND frame. The processor 811 sets the thus read values of OX_ID, S_ID, and D_ID in columns 1104, 1105, and 1106, respectively, in the table of FIG. 11B. From the destination port ID set in the column 1106 and the table of FIG. 11A, the processor 811 sets entries in the columns of source port ID 1107 and destination port ID 1108 after modification. To a frame that is inputted from the disk adapter to the switch, modification is made as exemplified by an entry line 1109. To a frame that is outputted from the switch to the disk adapter, modification is made as exemplified by an entry line 1110. In short, the processor 811 executes two types of frame modification processing. On the entry line 1109, the processor 811 changes only the destination port ID. On the entry line 1110, the processor 811 changes only the source port ID. The source ID change on the entry line 1110 is necessary to retain the consistency between the S_ID and D_ID of a frame that is sent to the disk adapter.

Then, the procedure proceeds to step 1004 in FIG. 10. In this step, the processor 811 changes the destination port ID D_ID in the frame, according to the table of FIG. 11B which has previously been set up, and recalculates CRC (Cyclic Redundancy Check) and replaces the CRC existing in the frame with the recalculated value.

If the result of the decision at step 1001 is No, the procedure proceeds to step 1005. The processor 811 reads OX_ID as exchange ID, D_ID as destination ID, and S_ID as source ID from within the frame and compares these values with the corresponding values set on each frame in the table of FIG. 11B. If the hit entries exist in the table (all the OX_ID, S_ID, D_ID entries on a line match those read from the frame), the procedure proceeds to step 1006. The processor 811 changes the source port ID S_ID and the destination ID D_ID in the frame, according to the table of FIG. 11B, and recalculates CRC and replaces the CRC existing in the frame with the recalculated value. Then, the procedure proceeds to step 1007 where the processor 811 detects whether the exchange ends. If the exchange ends, the procedure proceeds to step 1008 where the processor 811 deletes the entry line of the exchange from the table of FIG. 11B.

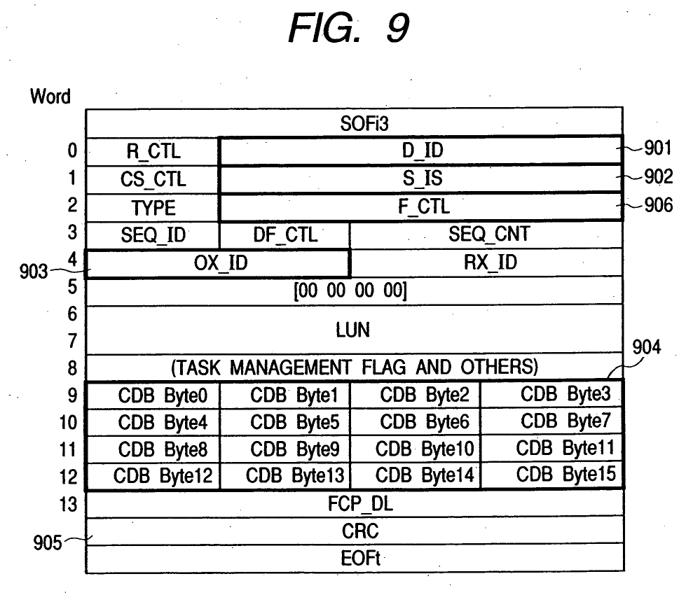

FIG. 9 shows a frame structure (FCP_CMND, as an example) including destination port ID 901, source port. ID 902, and exchange ID 903 and the type of the command 904 can easily be detected by checking error detection information 905 and exchange status 906.

In Embodiment 2 described hereinbefore, the switch executes frame modification processing and, consequently, the same operation as in Embodiment 1 can be implemented. An advantage of Embodiment 2 is that the load on the disk adapter can be reduced.

### Embodiment 3

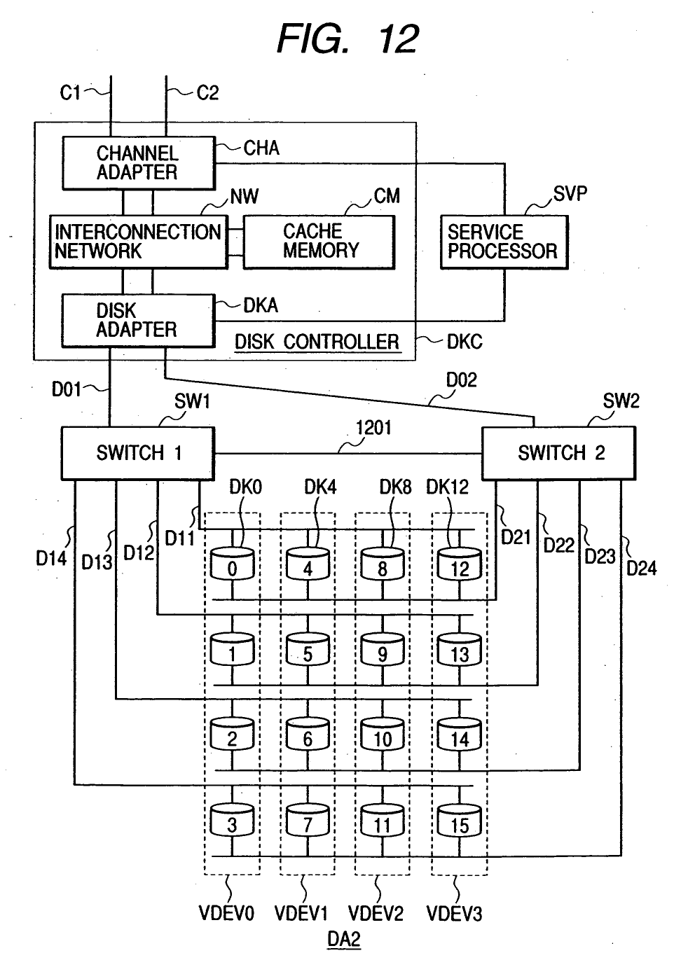

FIG. 12 shows a disk device configuration example according to a preferred Embodiment 3 of the invention. A feature of the disk device of Embodiment 3 lies in duplicated switches. In Embodiment 3, Fiber Channel is used for data transfer between a disk adapter and switches SW1 and SW2 and data transfer between the switches SW1 and SW2 and a disk array DA2.

The disk device of Embodiment 3 is comprised of a disk controller (DKC), the switches SW1 and SW2, and the disk array DA2. The disk controller is comprised of a channel adapter (CHA), a cache memory (CM), and a disk adapter (DKA).

The disk adapter and the switch SW1 are connected by a channel D01 and the disk adapter and the switch SW2 are connected by a channel D02. The switch SW1 and the switch SW2 are connected by a channel 1201.

Disk drives constituting the disk array DA2 each have two I/O ports. For example, disk drives DK0, DK4, DK8, and DK12 connect to both channels D11 and D21. The disk array DA2 consists of a disk array made up of four disks connected to the channels D11 and D21, a disk array made up of four disks connected to channels D12 and D22, a disk array made up of four disks connected to channels D13 and D23, and a disk array made up of four disks connected to channels D14 and D24. The channels, D11, D12, D13, D14, D21, D22, D23, and D24 form FC-ALs to connect the disk drives.

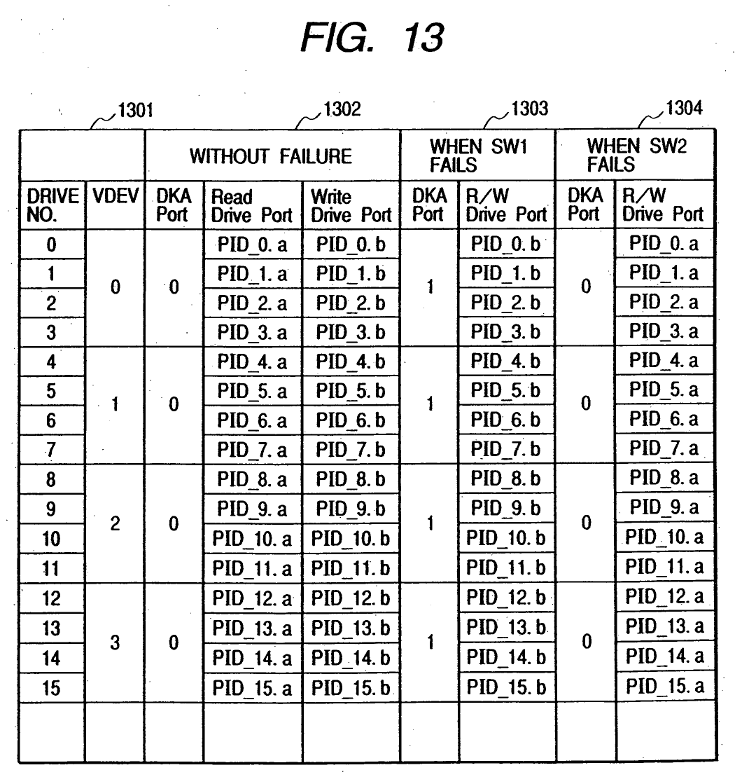

FIG. 13 shows an example of a back-end management table used in Embodiment 3. A column 1301 (VDEV) contains logical groups to one of which each disk drive belongs. Using the channel D01 if a DKA Port value in a column 1302, 1303, or 1304 is 0 or the channel D02 if this value is 1, the disk adapter connects to the switch SW1 or the switch SW2 and communicates with the disk array DA2. PID_0.a to PID_15.a correspond to the port IDs of the disk drives in the FC-ALs connected to the switch SW1. PID_0.b to PID_15.b correspond to the port IDs of the disk drives in the FC-ALs connected to the switch SW2. During normal operation (both the SW1 and SW2 do not fail), a Read command sent from the disk adapter is forwarded through the SW1 to any one of the destination ports PID_0.a to PID_15.a. Data that has been read is transferred in a reverse direction through the same path that the Read command was transferred. Meanwhile, a Write command and data to write are routed through the switch SW1, channel 1201, and switch SW2 and forwarded to any one of the destination ports PID_0.b to PID_15.b.

By way of example, operations of Read from a disk drive with drive number 0 and Write to a disk drive with drive number 4 are described. The Read command is transferred through a path going from the disk adapter, through the channel D01, switch SW1, channel D11, and to the PID_0.a port. The Write command is transferred through a path going from the disk adapter, through the channel D01, switch SW1, channel 1201, switch SW2, channel D21, and to the PID_4.b port. Because two different paths through which data can be transferred between the switches and the disk array are provided in this way and one of these paths is selected, according to the command type (Read/Write), a Read exchange and a Write exchange can be executed in parallel and full duplex operation between the disk adapter and the switch SW1 can be implemented.

If the switch SW1 has failed, the settings in the column 1303 in the table of FIG. 13 are applied. If the switch SW2 has failed, the settings in the column 1304 in the table of FIG. 13 are applied. Thus, even in the event that one switch has failed, the disk adapter can get access to the disk array DA2. However, during the failure of one switch, the number of commands that share one FC-AL bandwidth increases and, consequently, throughput may become lower than during normal operation.

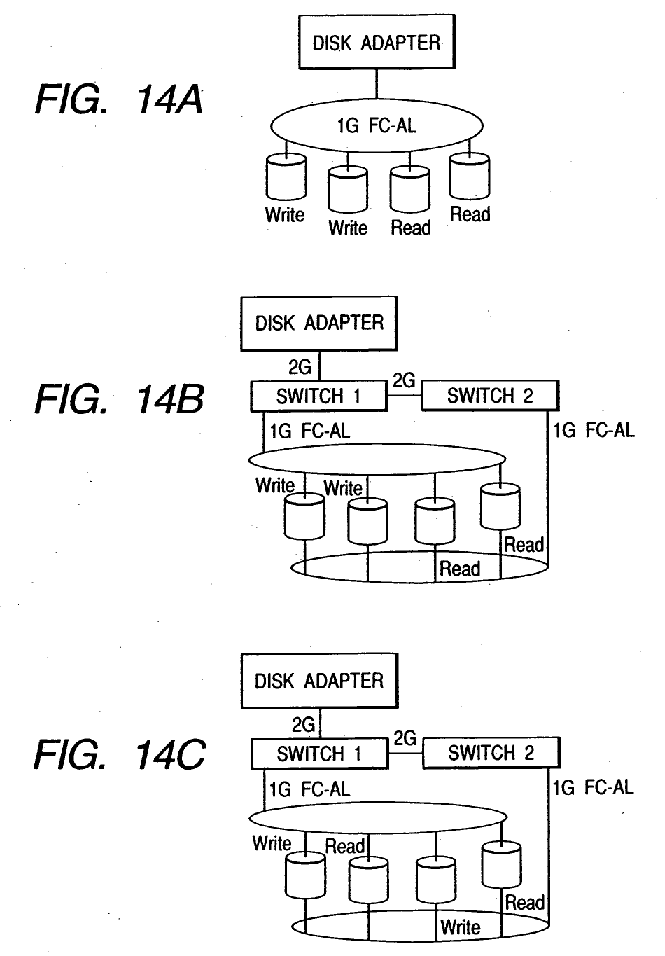

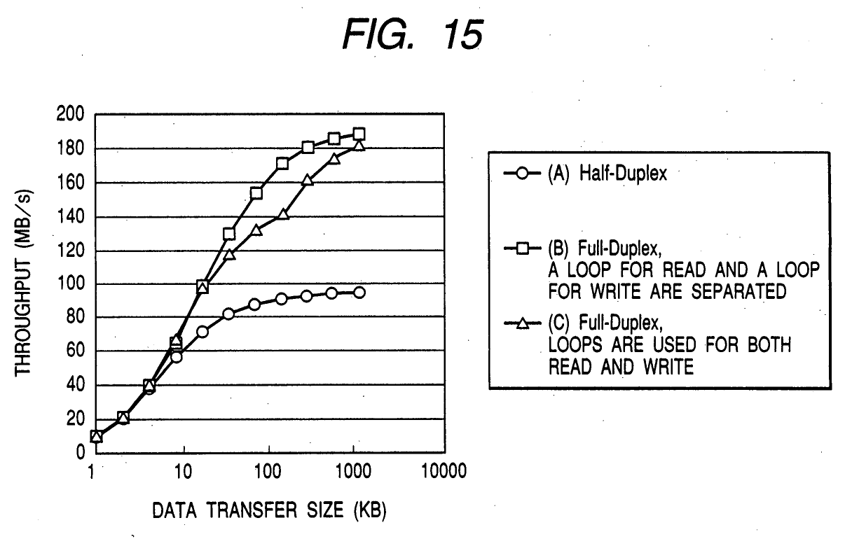

Using FIGS. 14A, 14B, 14C, and 15, a throughput enhancement effect of Embodiment 3 is explained. FIGS. 14A, 14B, and 14C show different topologies that were compared. FIGS. 14A, 14B, and 14C show the topologies where four disk drives are connected to one or two FC-ALs and Write to two disk drives and Read from the remaining two ones are executed. FIG. 14A is a conventional disk device topology. One FC-AL is directly connected to the disk adapter. The transfer rate of the loop is 1 Gbps. FIG. 14B is a topology example of Embodiment 3 where two loops are formed to be used for different command types (Read/Write). The transfer rate of the loops is 1 Gbps and the transfer rate of the channel between the disk adapter and one switch and the channel between two switches is 2 Gbps. FIG. 14C is another topology example of Embodiment 3 where different commands (Read/Write) are processed in a same loop, as a modification to the topology of FIG. 14B. The transfer rate of the loops is 1 Gbps and the transfer rate of the channel between the disk adapter and one switch and the channel between two switches is 2 Gbps.

FIG. 15 shows examples of throughput measurements on the topologies shown in FIGS. 14A, 14B, and 14C. In FIG. 15, throughput characteristic curves (A), (B), and (C) are plotted which correspond to the throughput characteristics of the topologies of FIG. 14A, FIG. 14B, and FIG. 14C, respectively. Data transfer size (KB) per command is plotted on the abscissa and throughput (MB/s) on the ordinate. As is apparent from the graph, the throughputs of the topologies of Embodiment 3 are seen to be significantly higher than the conventional topology (A) for data transfer size of 8 KB and over. It could be observed that the throughputs increase 36% for data transfer size of 16 KB and over and increase 87% for a domain of data transfer size of 128 KB and over, as compared with the conventional topology (A).

By comparison of the curves (B) and (C), it is found that the manner in which different loops are used for different commands (Read/Write) is more effective in enhancing throughput than the manner in which different commands are processed in same loop.

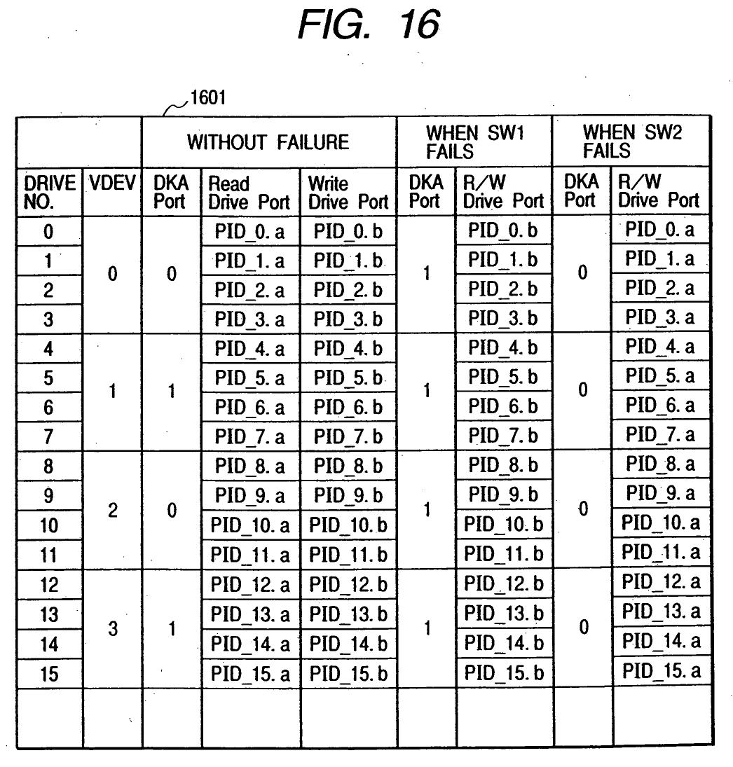

In Embodiment 3 described hereinbefore, one of the two I/O ports of the disk adapter is used for steady operation and the other port is an alternate to be used upon failover. However, of course, the two I/O ports may be used concurrently. FIG. 16 shows another example of the back-end management table when the two I/O ports of the disk adapter are used concurrently.

As denoted by two values set in a column 1601 in the table of FIG. 16, the disk adapter port to be used changes for different groups of disk drives. This setting enables the two disk adapter ports to share the load on the back-end network. Also, this setting has the effect of preventing the following: the failure of the alternate is detected only after the alternate is used upon failover.

### Embodiment 4

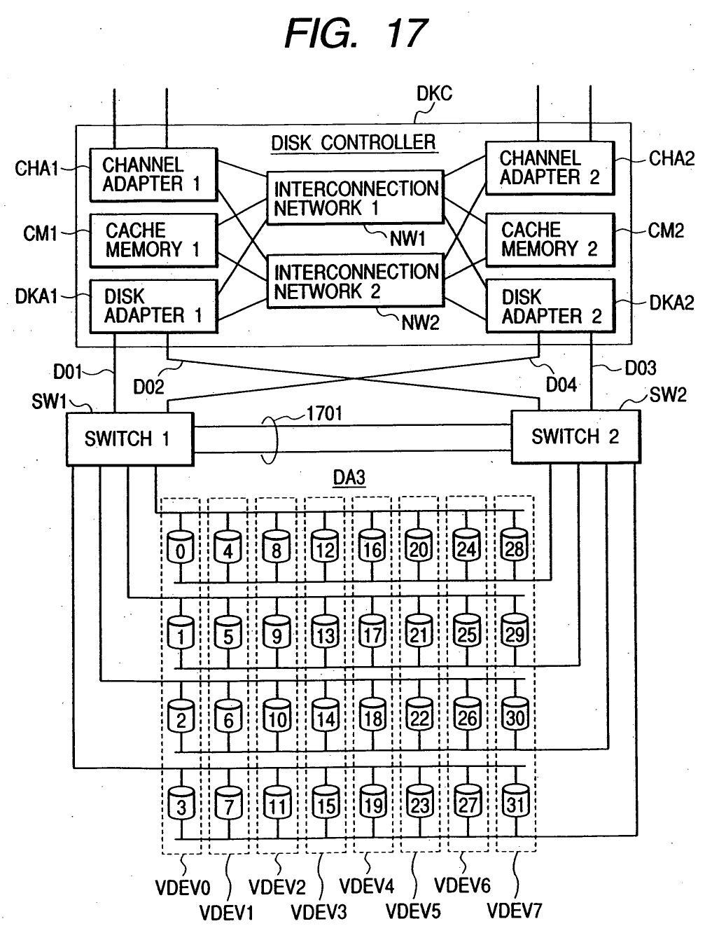

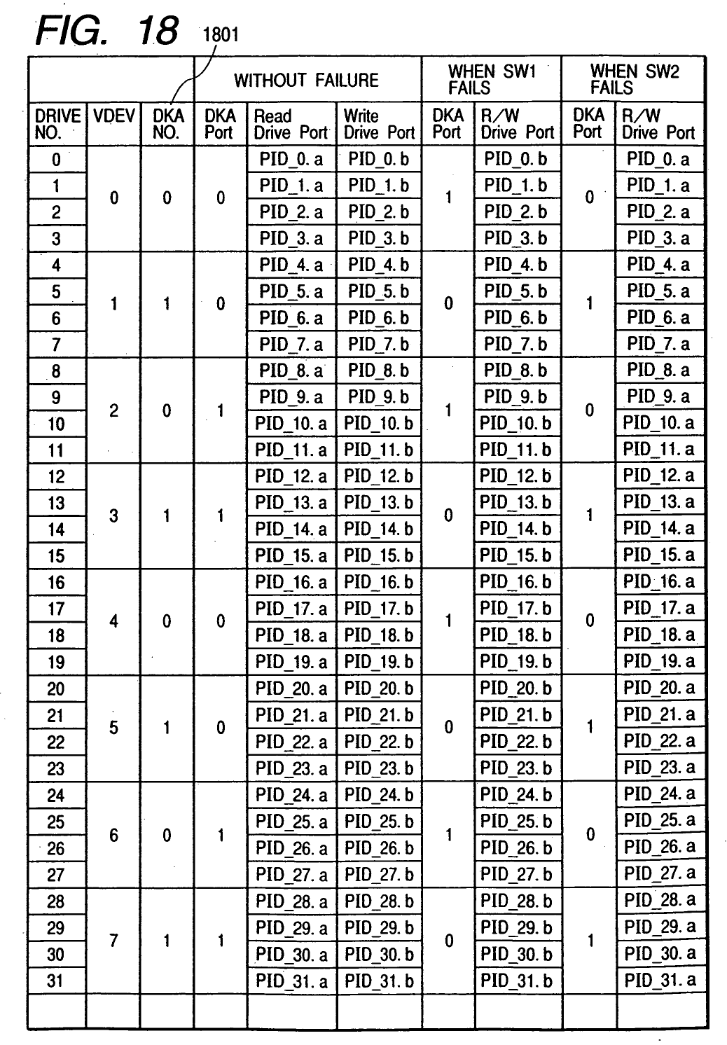

FIG. 17 shows a disk device configuration example according to a preferred Embodiment 4 of the invention. In Embodiment 4, Fiber Channel is used for data transfer between disk adapters DKA1, DKA2 and switches SW1 and SW2 and data transfer between the switches and the disk array DA3. Embodiment 4 has a feature that disk controller constituent elements are duplicated and the reliability is higher as compared with Embodiment 3. Channel adapters CHA1 and CHA2, cache memories CM1 and CM2, and the disk adapters DKA1 and DKA 2 are interconnected via two interconnection networks NW1 and NW2. The disk adapter DKA1 can connect to the disk array DA3 via the switch SW1 or SW2. Likewise, the disk adapter DKA2 can connect to the disk array DA3 via the switch SW1 or SW2. FIG. 18 shows an example of a back-end management table used in Embodiment 4. PID_0.a to PID31.a correspond to the port IDs of the disk drives in the FC-ALs connected to the switch SW1. PID_0.b to PID31.b correspond to the port IDs of the disk drives in the FC-ALs connected to the switch SW2. Using the channel D01 if the DKA Port value is 0 or the channel D02 if this value is 1, the disk adapter DKA1 connects to the switch SW1 or SW2 and communicates with the disk array DA3. Using the channel D03 if the DKA. Port value is 0 or the channel D04 if this value is 1, the disk adapter DKA2 connects to the switch SW1 or SW2 and communicates with the disk array DA3. The table of FIG. 18 includes a DKA number column 1801 which is added in contrast to the management table of FIG. 16. A value set in the column 1801 indicates which of the duplicated disk adapters is used. For example, if the DKA number is 0, the disk drive is accessed from the disk adapter DKA1. Otherwise, if the DKA number is 1, the disk drive is accessed from the disk adapter DKA 2. If one of the disk adapters has failed, the DKA number 1801 is changed in the management table so that the disk drives are accessed from the other disk adapter. According to Embodiment 4, an advantage lies in that the reliability can be enhanced because of the duplicated disk adapters and another advantage lines in that the two disk adapters can share the load during normal operation. Needless to say, a further advantage lies in the following: the destination disk drive port to which a frame is to be forwarded is determined, according to the type of a command that is issued by the disk adapter and, consequently, a higher throughput during full duplex operation is achieved, as is the case in Embodiments 1 to 3.

In the management table of FIG. 18, disk drive ports connected to the switch SW1 are assigned for Read access and disk drive ports connected to the switch SW2 are assigned for Write access (when the switches SW and SW2 do not fail). For example, data to write to drive 0 from the disk adapter DKA1 is transferred from the disk adapter DKA1, through the switch SW1, channel 1701, switch SW2 in order, and to the drive 0. Data read from drive 4 to the disk adapter DKA2 is transferred from the drive 4, through the switch SW1, channel 1701, switch, SW2 in order, and to the disk adapter DKA2. By the settings in the table of FIG. 18, data transfer on the channel 1701 that connects both the switches always occurs in one direction from the switch SW1 to the switch SW2.

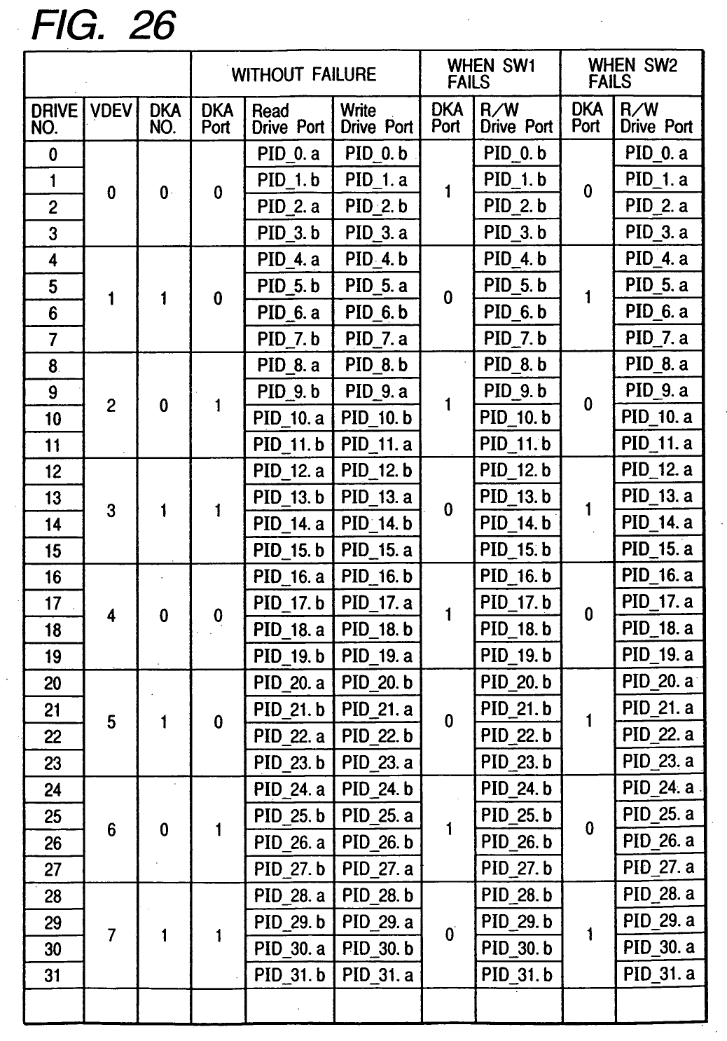

FIG. 26 shows another example of the back-end management table used in Embodiment 4. A feature of setup in the table of FIG. 26 is, that, among the disk drive ports connecting to the same switch, some are assigned for Read access ports and some are assigned for Write access ports, depending on the loop the disk drive belongs.

According to the table of FIG. 26, on the drives 0, 4, 8, 12 . . . 28 and on the drives 2, 6, 10, 14 . . . 30, ports connecting to the switch SW1 are assigned for Read access ports and ports connecting to the switch SW2 are assigned for Write access ports. Meanwhile, on the drives 1, 5, 9, 13 . . . 29 and on the drives 3, 7, 11, 15 . . . 31, ports connecting to the switch SW1 are assigned for Write access ports and ports connecting to the switch SW2 are assigned for Read access ports. For example, data to write to drive 0 is transferred from the disk adapter DKA1, through the switch SW1, channel 1701, switch SW2 in order, and to the drive 0. Meanwhile, data read from drive 1 is transferred from the drive 1, through the switch SW2, channel 1701, switch SW1 in order, and to the disk adapter DKA1. In this way, the drive ports connected to the same switch are divided in half into those to be accessed by a Read command and those to be accessed by a Write command, which is determined on a per-loop basis. This allows data to flow in two directions between the switches. Consequently, full duplex operation can be implemented on the channel 1701 as well. In contrast to the settings in the table of FIG. 18, by the settings in the table of FIG. 26, the number of physical lines constituting the channel 1701 that connects both the switches can be reduced.

### Embodiment 5

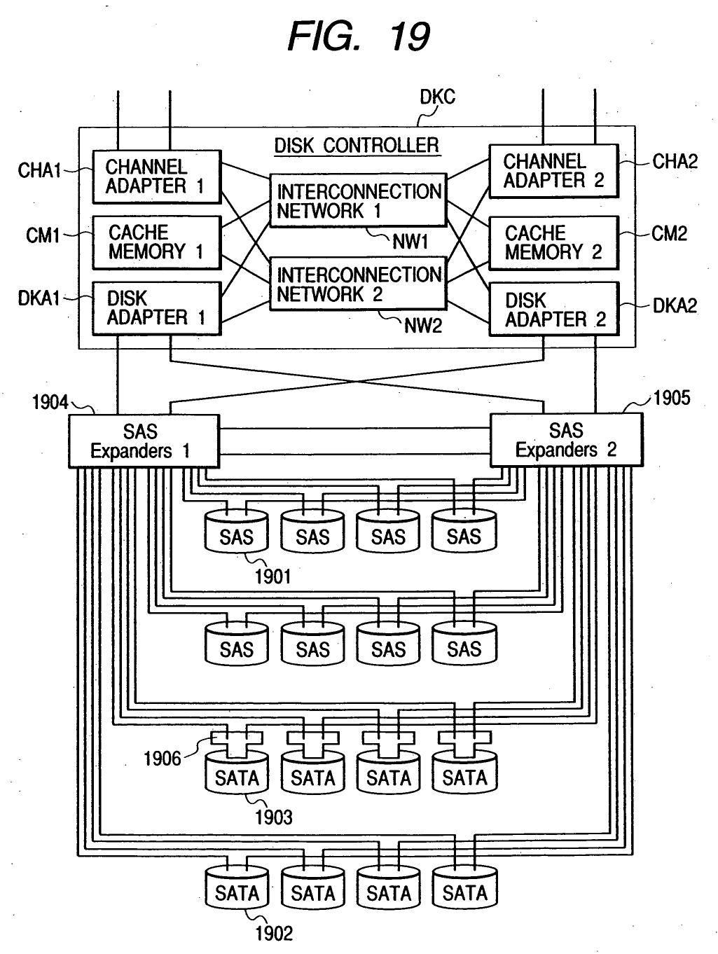

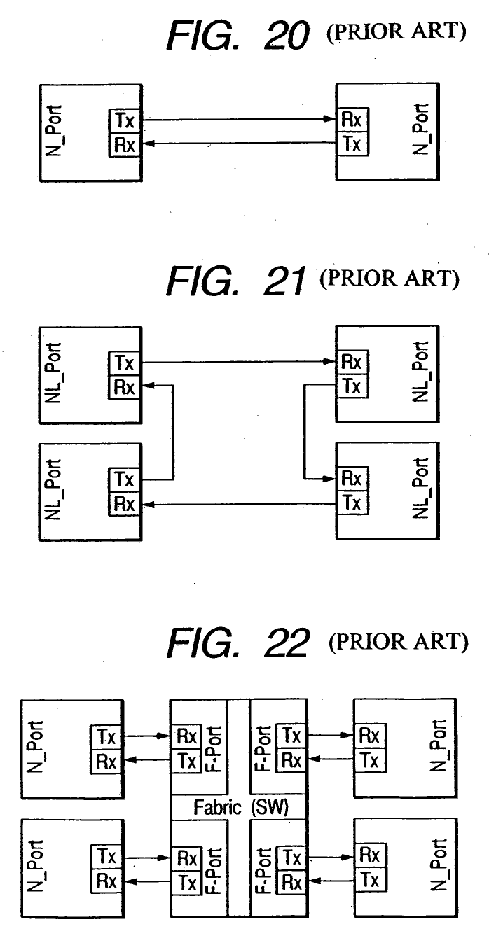

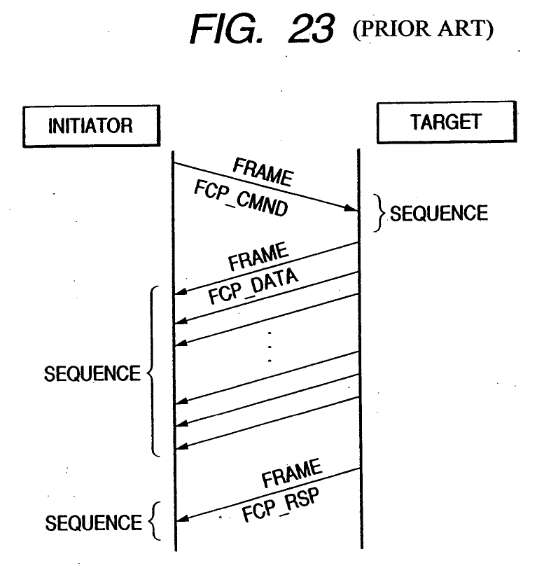

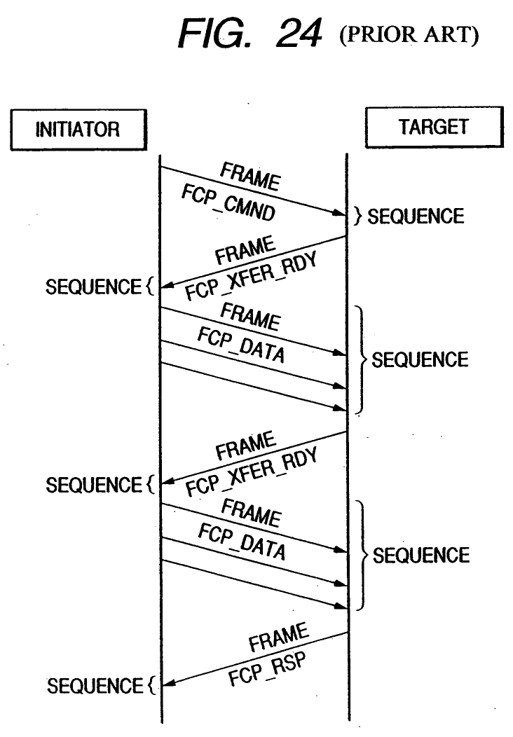

FIG. 19 shows a disk device configuration example according to a preferred Embodiment 5 of the invention. While the back-end network is formed with Fiber Channels in the above Embodiments 1 to 4, Embodiment 5 gives an example where Serial Attached SCSI (SAS) entities are used. The disk adapter DKA1 can connect to a disk array via an Expander 1904 or an Expander 1905. Likewise, the disk adapter DKA 2 can connect to the disk array via the Expander 1904 or the Expander 1905. Connection between the disk adapter DKA 1 and the Expanders 1 and 2, connection between the disk adapter DKA 2 and the Expanders 1 and 2, and connection between the Expanders are made by Wide ports. Connection between the Expanders and the disk drives are made by Narrow ports. The Expander corresponds to the switch of Fiber Channel, but does not support loop connection. Therefore, if a number of disk drives are connected, it may also be preferable to connect a plurality of Expanders in multiple stages and increase the number of ports for connection to the drives. Disk drives that can be used are SAS drives 1901 with two ports and, moreover, SATA (serial ATA) drives 1902 also can be connected. However, for SATA drives 1903 with a single I/O port, it must connect via a selector 1906 to the Expander 1904 and the Expander 1905. According to Embodiment 5, the SAS drives and SATA drives which are less costly than Fibre Channel drives can be employed and, therefore, the disk device is feasible with reduced cost. Needless to say, an advantage lies in the following: the destination disk drive port to which a frame is to be forwarded is determined, according to the type of a command that is issued by the disk adapter and, consequently, a higher throughput during full duplex operation is achieved, as is the case in Embodiments 1 to 4.

Furthermore, according to Embodiment 5, full duplex data transfer is implemented, while the two I/O ports of the disk devices are used steadily. This can prevent the following: the failure of an alternate disk drive port is detected only after failover occurs. Because disk adapter to disk adapter connection is made redundant with two Expanders, the back-end network reliability is high.

According to the present invention, a disk device having a back-end network that enables full duplex data transfer by simple control means can be realized and the invention produces an advantageous effect of enhancing the disk device throughput.

1.-9. (canceled)

10. A storage system, comprising:
a controller coupled to at least one information processing device and controlling to transfer of data sent from said information processing device;
a Serial Attached SCSI (SAS) Expander coupled to said controller and being used to relay data transferred from said controller; and
a plurality of SAS disk drives coupled to said SAS Expander by point-to-point and storing data relayed via said SAS Expander;
wherein said SAS Expander coupled to said controller via at least one Wide port and coupled to each of said SAS disk drives via at least one Narrow port, and
wherein a number of said Wide port is less than a number of a plurality of said Narrow port.

11. A storage system according to claim 10, further comprising:
another controller coupled to said information processing device or another information processing device and controlling to transfer of data sent from said information processing device or said another information processing device;
wherein said SAS Expander coupled to said another controller via another Wide port and being able to relay data transferred from said another controller to at least one of said SAS disk drives.

12. A storage system according to claim 11, further comprising:
another SAS Expander coupled to said controller and said another controller and coupled to said SAS disk drives by point-to-point and being used to relay data transferred from said controller or said another controller to at least one of said SAS disk drives.

13. A storage system according to claim 12:
wherein each of said SAS disk drives has at least 2 ports, one of said 2 ports coupled to said SAS Expander, another of said 2 ports coupled to said another SAS Expander.

14. A storage system according to claim 12:
wherein said SAS Expander coupled to said another SAS Expander and being able to relay data to said another SAS Expander.

15. A storage system according to claim 12:
wherein two or more of said SAS disk drives are assigned to a same logical group.

16. A storage system according to claim 12, further comprising:
a plurality of Serial Advanced Technology Attachment (SATA) disk drives coupled to said SAS Expander by point-to-point and coupled to said another SAS Expander by point-to-point and storing data relayed via said SAS Expander or said another SAS Expander.

17. A storage system according to claim 16:
wherein two or more among said SAS disk drives and said SATA disk drives are assigned to a same logical group.

18. A storage system according to claim 16:
wherein each of said SATA disk drives coupled to said SAS Expander or said another SAS Expander via a selector, said selector selecting a connection with either said SAS Expander or said another SAS Expander.

19. A storage system according to claim 12, further comprising:
another layer SAS Expander coupled to said SAS Expander and coupled to a plurality of another SAS disk drives by point-to-point and being used to relay data transferred via said SAS Expander to at least one of said another SAS disk drives.

20. A storage system according to claim 19:
wherein said another layer SAS Expander coupled to said SAS via at least one another Wide port and coupled to each of said another SAS disk drives via at least one another Narrow port, and
wherein a number of said another Wide port is less than a number of a plurality of said another Narrow port.

21. A storage system according to claim 10, further comprising:
another SAS Expander coupled to said controller and coupled to said SAS disk drives by point-to-point and being used to relay data transferred from said controller to at least one of said SAS disk drives.

22. A storage system according to claim 21:
wherein each of said SAS disk drives has at least 2 ports, one of said 2 ports coupled to said SAS Expander, another of said 2 ports coupled to said another SAS Expander.

23. A storage system according to claim 21:
wherein said SAS Expander coupled to said another SAS Expander and being able to relay data to said another SAS Expander.

24. A storage system according to claim 21:
wherein two or more of said SAS disk drives are assigned to a same logical group.

25. A storage system according to claim 21, further comprising:
a plurality of Serial Advanced Technology Attachment (SATA) disk drives coupled to said SAS Expander by point-to-point and coupled to said another SAS Expander by point-to-point and storing data relayed via said SAS Expander or said another SAS Expander.

26. A storage system according to claim 25:
wherein two or more among said SAS disk drives and said SATA disk drives are assigned to a same logical group.

27. A storage system according to claim 25:
wherein each of said SATA disk drives coupled to said SAS Expander or said another SAS Expander via a selector, said selector selecting a connection with either said SAS Expander or said another SAS Expander.

28. A storage system according to claim 21, further comprising:
another layer SAS Expander coupled to said SAS Expander and coupled to a plurality of another SAS disk drives by point-to-point and being used to relay data transferred via said SAS Expander to at least one of said another SAS disk drives.

29. A storage system according to claim 28:
wherein said another layer SAS Expander coupled to said SAS Expander via at least one another Wide port and coupled to each of said another SAS disk drives via at least one another Narrow port, and
wherein a number of said another Wide port is less than a number of a plurality of said another Narrow port.

30. A storage system according to claim 10:
wherein two or more of said SAS disk drives are assigned to a same logical group.

31. A storage system according to claim 10, further comprising:
a plurality of Serial Advanced Technology Attachment (SATA) disk drives coupled to said SAS Expander by point-to-point and storing data relayed via said SAS Expander.

32. A storage system according to claim 31:
wherein two or more among said SAS disk drives and said SATA disk drives are assigned to a same logical group.

33. A storage system according to claim 10, further comprising:
another layer SAS Expander coupled to said SAS Expander and coupled to a plurality of another SAS disk drives by point-to-point and being used to relay data transferred via said SAS Expander to at least one of said another SAS disk drives.

34. A storage system according to claim 33:
wherein said another layer SAS Expander coupled to said SAS Expander via at least one another Wide port and coupled to each of said another SAS disk drives via at least one another Narrow port, and
wherein a number of said another Wide port is less than a number of a plurality of said another Narrow port.

35. A storage system, comprising:
a first controller coupled to at least one information processing device and controlling to transfer of data sent from said information processing device;
a Serial Attached SCSI (SAS) switching device coupled to said first controller and being used to relay data transferred from said first controller; and
a plurality of SAS disk drives coupled to said SAS switching device by point-to-point and storing data relayed via said SAS switching device;
wherein said SAS switching device coupled to said controller via at least one first port and coupled to each of said SAS disk drives via at least one second port, a data transfer rate of said first port is faster than a data transfer rate of the second port, and
wherein a number of said first port is less than a number of a plurality of said second port.

36. A storage system according to claim 35, further comprising:
another controller coupled to said information processing device or another information processing device and controlling to transfer of data sent from said information processing device or said another information processing device;
wherein said SAS switching device coupled to said another controller via third port and being able to relay data transferred from said another controller to at least one of said SAS disk drives, a data transfer rate of said third port is faster than a data transfer rate of the second port.

37. A storage system according to claim 35, further comprising:
another SAS switching device coupled to said controller and coupled to said SAS disk drives by point-to-point and being used to relay data transferred from said controller to at least one of said SAS disk drives.

38. A storage system according to claim 35:
wherein two or more of said SAS disk drives are assigned to a same logical group.

39. A storage system according to claim 35, further comprising:
a plurality of Serial Advanced Technology Attachment (SATA) disk drives coupled to said SAS switching device by point-to-point and storing data relayed via said SAS switching device.

40. A storage system according to claim 39:
wherein two or more among said SAS disk drives and said SATA disk drives are assigned to a same logical group.

41. A storage system according to claim 35, further comprising:
another SAS switching device coupled to said SAS switching device and coupled to a plurality of another SAS disk drives by point-to-point and being used to relay data transferred via said SAS switching device to at least one of said another SAS disk drives.

42. A storage system according to claim 41:
wherein said another SAS switching device coupled to said SAS switching device via at least one fourth port and coupled to each of said another SAS disk drives via at least one fifth port, a data transfer rate of said fourth port is faster than a data transfer rate of said fifth port, and
wherein a number of said fourth port is less than a number of a plurality of said fifth port.

43. A storage system according to claim 35:
wherein said SAS switching device is a SAS Expander.
